(19) United States
(12) Patent Application Publication
(10) Pub. No.: US 2020/0309013 A1
(43) Pub. Date: Oct. 1, 2020

(54) EXHAUST PIPE STRUCTURE

(71) Applicant: Toyota Jidosha Kabushiki Kaisha, Toyota-shi Aichi-ken (JP)

(72) Inventor: Masataka Tasaka, Seto-shi Aichi-ken (JP)

(21) Appl. No.: 16/818,081

(22) Filed: Mar. 13, 2020

(30) Foreign Application Priority Data
Mar. 27, 2019 (JP) 2019-061096

(51) Int. Cl. F01N 13/10; F01N 13/18; F01N 3/28; F02B 75/22; F01M 11/00

(52) U.S. Cl. CPC F01N 13/107; F01N 13/1816; F01M 11/0004; F02B 75/22; F01N 3/28

(57) ABSTRACT

An exhaust pipe structure includes a front bank exhaust pipe connected to an exhaust manifold on a front bank of the V engine; an intermediate exhaust pipe connected to a downstream side of the front bank exhaust pipe; and a rear exhaust pipe connected to a downstream side of the intermediate exhaust pipe, wherein the front bank exhaust pipe and the intermediate exhaust pipe are connected with each other via a ball joint, the intermediate exhaust pipe and the rear exhaust pipe are connected with each other via a ball joint, and a flexible pipe is attached to the front bank exhaust pipe.

### CROSS REFERENCE TO RELATED APPLICATION

This application claims priority to Japanese Patent Application No. 2019-061096 filed on Mar. 27, 2019, which is incorporated herein by reference in its entirety including the specification, claims, drawings, and abstract.

### TECHNICAL FIELD

The present disclosure relates to an exhaust pipe structure connected to an engine.

### BACKGROUND

Japanese Patent Laid-Open No. 2008-019713 discloses an exhaust pipe structure in which, in order to inhibit transmission of vibration of an, exhaust pipe connected to an exhaust manifold of an engine, the exhaust pipe is divided into multiple segments in a flow direction and coupling portions of the resulting exhaust pipe segments are bendably connected by universal joints such as ball joints.

Currently, an exhaust pipe structure connected to an exhaust manifold of a transverse-mounted V engine uses a structure in which a ball joint is placed on an upstream side of a catalytic device installed at an intermediate position and a flexible pipe is placed on a downstream, side of the catalytic device. Such a structure involves a vibration mode of an entire exhaust system that uses a flexible pipe as a spring element and a vibration mode originating from an exhaust pipe layout up to an upstream side of the flexible pipe. Because the two vibration modes are close to each other in peak frequency, if output torque of the engine increases when the engine and a transmission are coupled, resonance occurs, which may aggravate vibration of an engine mount and muffled sound inside a vehicle due to coupled vibration of the engine and an exhaust system. This imposes restrictions on an engine operating range in which the engine and transmission can be coupled, and thereby restricts improvement of fuel efficiency.

Thus, it is an advantage of the present disclosure is to reduce exhaust pipe-induced vibration of an engine mount and muffled sound inside a vehicle in a coupled state, expand an engine operating range in which the engine and a transmission can be coupled, and thereby improve vehicle fuel efficiency and drivability performance.

According to the present disclosure, there is provided an exhaust pipe structure connected to a V engine placed transversely in front part of a vehicle, the exhaust pipe structure comprising: a front bank exhaust pipe connected to an exhaust manifold on a front bank of the V engine; a rear bank exhaust pipe adapted to connect an exhaust manifold on a rear bank of the V engine to the front bank exhaust pipe; an intermediate exhaust pipe connected to a downstream side of the front bank exhaust pipe, with a catalytic device being attached to the intermediate exhaust pipe; and a rear exhaust pipe connected to a downstream side of the intermediate exhaust pipe, with a muffler being attached to the rear exhaust pipe; wherein the front bank exhaust pipe and the intermediate exhaust pipe are connected with each other via a ball joint, the intermediate exhaust pipe and the rear exhaust pipe are connected with each other via a ball joint, and a flexible pipe, elastically deformable, is attached to the front bank exhaust pipe on a side upstream of a branched section between the front bank exhaust pipe and the rear bank exhaust pipe.

In this way, since the flexible pipe is attached to the front bank exhaust pipe on the side upstream of the branched section where the front bank exhaust pipe joins the rear bank exhaust pipe and the front bank exhaust pipe and the intermediate exhaust pipe are connected with each other via, a ball joint, a vibration mode of the exhaust pipe structure becomes a 3-node bending vibration mode. In this vibration mode, vibration can be suppressed by the ball joint installed between the intermediate exhaust pipe and the rear exhaust pipe and exhaust pipe-induced vibration of an engine mount and muffled sound inside the vehicle can be reduced under conditions in which the engine and transmission are coupled. This makes it possible to expand an engine operating range in which the engine and transmission can be coupled and thereby improve vehicle fuel efficiency and drivability performance.

In one aspect of the exhaust pipe structure according to the present disclosure, the flexible pipe may be placed under an oil pan of the V engine.

This aspect makes it possible to more reliably reduce exhaust pipe-induced vibration of the engine mount and muffled sound inside the vehicle in a coupled area.

The present disclosure makes it possible to reduce exhaust pipe-induced vibration of the engine mount and muffled sound inside the vehicle, expand the engine operating range in which the engine and transmission can be coupled, and thereby improve vehicle fuel efficiency and drivability performance.

### BRIEF DESCRIPTION OF DRAWINGS

An embodiment of the present disclosure will be described based on the following figures, wherein:

FIG. 1 is a side view of an exhaust pipe structure according to an embodiment of the present disclosure;

FIG. 2 is a top view of the exhaust pipe structure according to the present embodiment;

FIG. 3 is sectional view showing a schematic configuration of a ball joint;

FIG. 4 is a diagram explaining a 3-node vibration mode by showing vibration of the exhaust pipe structure according to the present embodiment;

FIG. 5 is a top view of an exhaust pipe structure according to Comparative Example 1;

FIG. 6 is a graph comparing vibration levels of engine mounts between the exhaust pipe structure of the present embodiment and the exhaust pipe structure of Comparative Example 1; and

FIG. 7 is a diagram comparing ranges in which an engine and transmission can be used in a full coupled state between the exhaust pipe structure of the present embodiment and the exhaust pipe structure of Comparative Example 1.

### DESCRIPTION OF EMBODIMENTS

An exhaust pipe structure 10 according to an embodiment will be described below with reference to the drawings. An FR-arrow, UP-arrow, and RH-arrow shown in the drawings described below indicate a front direction (traveling direction), an up direction, and a right-hand direction of a vehicle, respectively. Also, directions opposite the FR-arrow, UP-arrow, and RH-arrow are a rear direction, a down direction, and a left-hand direction of the vehicle, respectively. The front/rear, left/right, and up/down directions, when simply referred to hereinafter, mean the front/rear direction, left/right direction (vehicle width direction), and up/down direction with respect to the vehicle, respectively, unless otherwise noted.

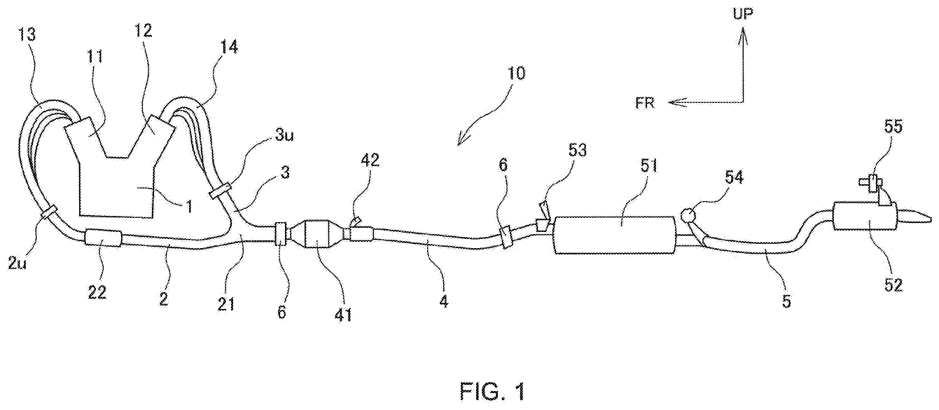

As shown in FIG. 1, the exhaust pipe structure 10 is connected to a V engine 1 placed transversely in front part of the vehicle, and is adapted to lead exhaust gas rearward along the vehicle from the V engine 1. The exhaust pipe structure 10 includes a front bank exhaust pipe 2 connected to an exhaust manifold 13 on a front bank 11 of the V engine 1, a rear bank exhaust pipe 3 adapted to connect an exhaust manifold 14 on a rear bank 12 of the V engine 1 to the front bank exhaust pipe 2, an intermediate exhaust pipe 4 connected to a downstream side of the front bank exhaust pipe 2, and a rear exhaust pipe 5 connected to a downstream side of the intermediate exhaust pipe 4. The front bank exhaust pipe 2 is permanently connected to the exhaust manifold 13 on the front bank 11. The rear bank exhaust pipe 3 is permanently connected at one end to the exhaust manifold 14 on the rear bank 12 and permanently connected at another end to a branched section 21 of the front bank exhaust pipe 2. The intermediate exhaust pipe 4 is connected to the front bank exhaust pipe 2 via a ball joint 6. The rear exhaust pipe 5 is connected to the intermediate exhaust pipe 4 via a ball joint 6.

Exhaust discharged from cylinders on the front bank 11 of the V engine 1 flows to the front bank exhaust pipe 2 from the exhaust manifold 13. Exhaust discharged from cylinders on the rear bank 12 flows to the rear bank exhaust pipe 3 from the exhaust manifold 14 and joins the exhaust discharged from the cylinders on the front bank 11 at the branched section 21. Then, the exhaust, oining together at the branched section 21 flows rearward along the vehicle through the intermediate exhaust pipe 4 and rear exhaust pipe 5 and is discharged outside.

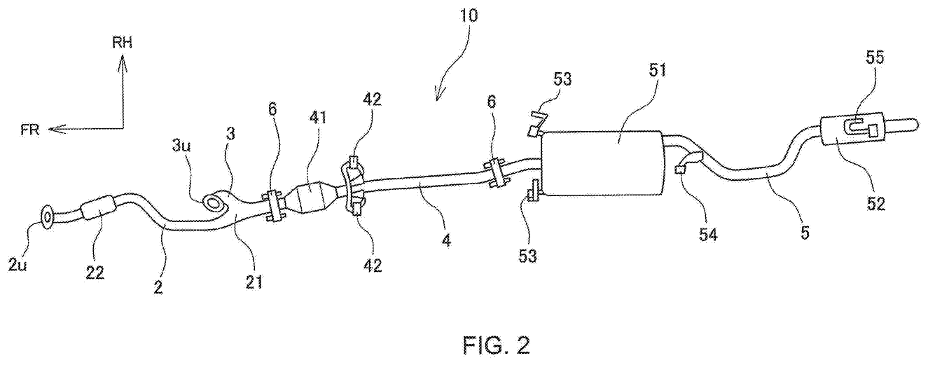

As shown in FIGS. 1 and 2, a catalytic device 41 is attached to the intermediate exhaust pipe 4. The exhaust discharged from the V engine 1 is purified of toxic substances by the catalytic device 41 and then discharged outside through the rear exhaust pipe 5. A main muffler 51 and sub-muffier 52 are, attached to the rear exhaust pipe 5. The main muffler 51 mainly reduces low-frequency exhaust sound and the sub muffler 52 mainly reduces high-frequency exhaust sound.

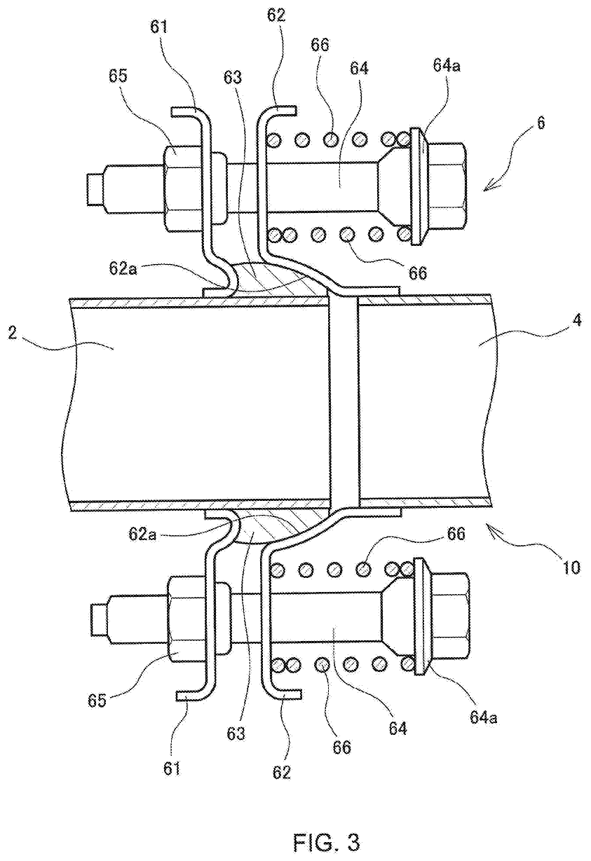

FIG. 3 is sectional view showing a schematic configuration of the ball joint 6 interconnecting the front bank exhaust pipe 2 and intermediate exhaust pipe 4. As shown in FIG. 3, the ball joint 6 includes a nut-side flange 61 fixed to the front bank exhaust pipe 2, a bolt-side flange 62 fixed to the intermediate exhaust pipe 4, and a sealing member 63 in spherical contact with a spherical portion 62a of the bolt-side flange 62. Bolts 64 are fixed to the nut-side flange 61 by nuts 65. Also, a compressed coiled spring 66 is placed between a head 64a of each bolt 64 and the bolt-side flange 62, urging the nut-side flange 61 and bolt-side flange 62 in such directions as to come close to each other. Consequently, the nut side flange 61 and bolt side flange 62 hold the sealing member 63, ensuring airtightness. Then, as the spherical portion 62a of the bolt-side flange 62 and the sealing member 63 slide over each other, the front bank exhaust pipe 2 and intermediate exhaust pipe 4 are bendably connected to each other. Similarly, the intermediate exhaust pipe 4 and rear exhaust pipe 5 are bendably connected to each other by the ball joint 6.

As shown in FIGS. 1 and 2, the front bank exhaust pipe 2 running from an upstream end 2u to the branched section 21 is longer in pipe length than the rear bank exhaust pipe 3 running from an upstream end 3u to the branched section 21. The front bank exhaust pipe 2 is running under an oil pan of the V engine 1. In addition, a flexible pipe 22, elastically deformable, is attached to the front bank exhaust pipe 2 on the side upstream of the branched section 21 where the front bank exhaust pipe 2 joins the rear bank exhaust pipe 3. The flexible pipe 22 is placed under the oil pan of the V engine 1. The flexible pipe 22 has a structure in which a cylindrical bellows with a corrugated structure is covered circumferentially with a cylindrical cover. The bellows can be expanded and contracted axially, and bent. The bellows is covered with the cylindrical cover to prevent the bellows from being hit by pebbles bouncing off road surfaces and thereby being damaged.

The intermediate exhaust pipe 4 is supported on a non-illustrated vehicle body by two intermediate exhaust pipe supports 42 installed on the side downstream of the catalytic device 41. The rear exhaust pipe 5 is supported on the vehicle body by two main-muffler supports 53, a rear exhaust pipe support 54, and a sub-muffler support 55. The two main-muffler supports 53 are both installed on a front side of the main muffler 51. The rear exhaust pipe support 54 is installed on that part of the rear exhaust pipe 5 which is located on the side downstream of the main muffler 51. The sub-muffler support 55 is installed on an upper side of the sub-muffler 52.

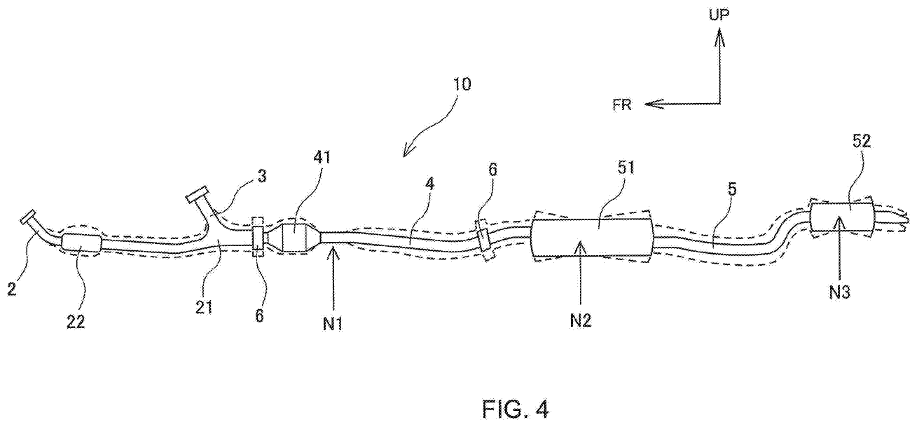

In the exhaust pipe structure 10, as described earlier, the flexible pipe 22 is installed on the front bank exhaust pipe 2 on the side upstream of the branched section 21 where the front bank exhaust pipe 2 joins the rear bank exhaust pipe 3 and the front bank exhaust pipe 2 and intermediate exhaust pipe 4 are connected to each other by the ball joint 6. Therefore, the vibration mode of the exhaust pipe structure 10 is a 3-node bending vibration mode. In addition, in the exhaust pipe structure 10, since the flexible pipe 22 is placed under the oil pan of the V engine 1, the vibration mode of the exhaust pipe structure 10 is a 3-node bending vibration mode whose three nodes are node N1, node N2, and node N3 as shown in FIG. 4. Node N1 is located on a downstream side of the catalytic device 41, node N2 is located at the position of the main muffler 51, and node N3 is located at the position of the sub-muffler 52. FIG. 4 is a side view of the exhaust pipe structure 10, where a state in which the exhaust pipe structure 10 is not vibrating is indicated by solid lines and a state in which the exhaust pipe structure 10 is vibrating up and down is indicated by broken lines. Note that in FIG. 4, illustration of the intermediate exhaust pipe supports 42, main-muffler supports 53, rear exhaust pipe support 54, and sub-muffler support 55 is omitted and the exhaust pipe structure 10 is shown in simplified form. In the 3-node bending vibration mode, vibration can be suppressed by the ball joint 6 installed between the intermediate exhaust pipe 4 and rear exhaust pipe 5. This makes it possible to reduce exhaust pipe-induced vibration of an engine mount (not shown) and muffled sound inside the vehicle under conditions in which the V engine 1 and transmission (not shown) are coupled. Note that on the side upstream of the branched section 21 where the front bank exhaust pipe 2 joins the rear bank exhaust pipe 3, the most suitable position to install the flexible pipe 22 is under the oil pan of the V engine 1. When the flexible pipe 22 is installed in this position, it is possible to more reliably reduce exhaust pipe-induced vibration of the engine mount and muffled sound inside the vehicle under conditions in which the V engine 1 and transmission are coupled than when the flexible pipe 22 is installed in another position.

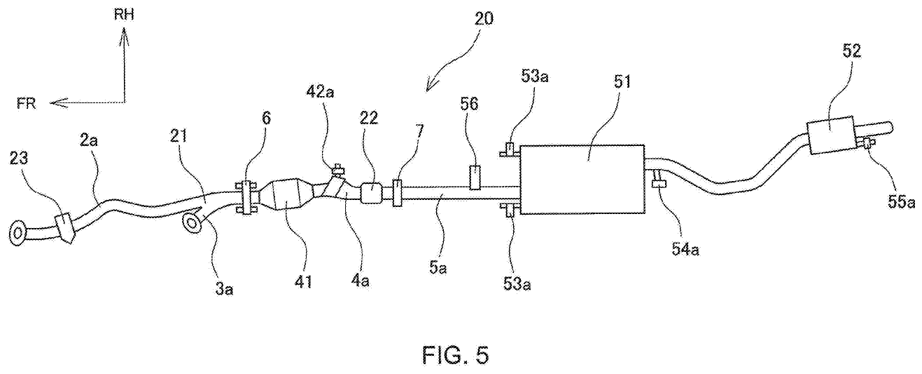

To describe the reductions in the exhaust pipe-induced vibration of the engine mount and muffled sound inside the vehicle, an exhaust pipe structure 20 of Comparative Example 1 will be described below. As with the exhaust pipe structure 10 of the present embodiment, the exhaust pipe structure 20 of Comparative Example 1 is connected to a V engine placed transversely in front part of a vehicle. As shown in FIG. 5, the exhaust pipe structure 20 includes a front bank exhaust pipe 2a connected to an exhaust manifold on a front bank of the V engine, a rear bank exhaust pipe 3a adapted to connect an exhaust manifold on a rear bank to the front bank exhaust pipe 2a, an intermediate exhaust pipe 4a connected to a downstream side of the front bank exhaust pipe 2a, and a rear exhaust pipe 5a connected to a downstream side of the intermediate exhaust pipe 4a. In addition, as with the exhaust pipe structure 10 of the present embodiment, a catalytic device 41 is attached to the intermediate exhaust pipe 4a and a main muffler 51 and a sub-muffler 52 are attached to the rear exhaust pipe 5a.

Also, as with the exhaust pipe structure 10 of the present embodiment, in the exhaust pipe structure 20 of Comparative Example 1, the front bank exhaust pipe 2a is permanently connected to the exhaust manifold on the front bank of the V engine. Moreover, the rear bank exhaust pipe 3a is permanently connected to the exhaust manifold on the rear bank of the V engine and is permanently connected to the front bank exhaust pipe 2a at a branched section 21. The intermediate exhaust pipe 4a is connected to the front bank exhaust pipe 2a via a ball joint 6.

However, in the exhaust pipe structure 20 of Comparative Example 1, unlike the exhaust pipe structure 10 of the present, embodiment, the rear exhaust pipe 5a is permanently connected to the intermediate exhaust pipe 4a in a connecting portion 7. In addition, a flexible pipe 22 is attached to the inter iediate exhaust pipe 4a rather than to the front bank exhaust pipe 2a. Furthermore, a dynamic damper 56 is installed on the rear exhaust pipe 5a on the side upstream of the main muffler 51 to absorb vibration.

The front bank exhaust pipe 2a is fixed to the V engine by an exhaust pipe fixing bracket 23 on the side upstream of the branched section 21 between the front bank exhaust pipe 2a and rear bank exhaust pipe 3a. The intermediate exhaust pipe 4a is supported on a vehicle body by an intermediate exhaust pipe support 42a installed on the side downstream of the catalytic device 41. The rear exhaust pipe 5a is supported on, the vehicle body by two main-muffler supports 53a, a rear exhaust pipe support 54a, and a sub-muffler support 55a. The two main-muffler supports 53a are both installed on a ffont side of the main muffler 51. The rear exhaust pipe support 54a is installed on that part of the rear exhaust pipe 5a which is located on the side downstream of the main muffler 51. The sub-muffler support 55a is installed behind the sub-muffler 52.

The exhaust pipe structure 20, in which the flexible pipe 22 is attached to the intermediate exhaust pipe 4a, involves a vibration mode of an entire exhaust system that uses the flexible pipe 22 as a spring element and a vibration mode originating from an exhaust pipe layout up to an upstream side of the flexible pipe 22. The vibration mode of the entire exhaust system that uses the flexible pipe 22 as a spring element and the vibration mode originating from the exhaust pipe layout up to the upstream side of the flexible pipe 22 are close to each other in peak frequency. Consequently, with the exhaust pipe structure 20 of Comparative Example 1, when the V engine (hereinafter referred to simply as the engine) and a transmission are coupled, vibration of the engine mount may be aggravated by coupled vibration of the engine and exhaust system, aggravating muffled sound inside the vehicle, floor vibration, and steering vibration. The peaks of the vibrations are tuned by pipe rigidity and by addition of the dynamic damper 56, but this does not solve the resonance itself. This imposes restrictions on an engine operating range in which the engine and transmission can be coupled, and thereby restricts improvement of fuel efficiency.

In contrast, in the exhaust pipe structure 10 of the present embodiment, since the flexible pipe 22 is installed on the side upstream of the branched section 21 of the front bank exhaust pipe 2 rather than being attached to the intermediate exhaust pipe 4, rigidity of the front bank exhaust pipe 2 running from the upstream end 2u to the branched section 21 changes and the two vibration modes occurring in the exhaust pipe structure 20 of Comparative Example 1 are eliminated. Moreover, as described earlier, the exhaust pipe structure 10 of the present embodiment has a 3-node bending vibration mode whose three nodes are node N1, node N2, and node N3 shown in FIG. 4. Compared to the exhaust pipe structure 20 of comparative Example 1, the 3-node bending vibration mode, in which vibration can be suppressed by the ball joint 6 installed between the intermediate exhaust pipe 4 and rear exhaust pipe 5, can reduce the exhaust pipe-induced vibration of the engine mount and muffled sound inside the vehicle under conditions in which the engine and transmission are coupled.

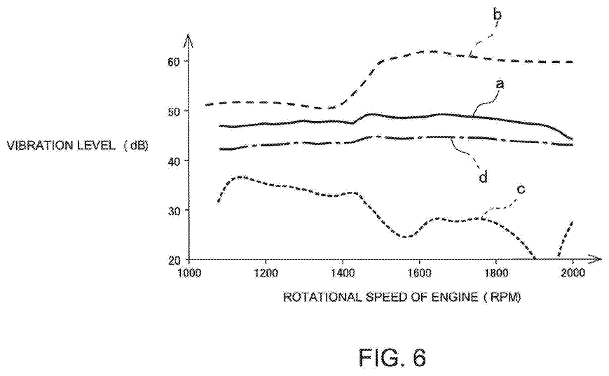

FIG. 6 is a graph comparing measured vibration levels of up-down vibrations of engine mounts between the exhaust pipe structure 10 of the present embodiment and the exhaust pipe structure 20 of Comparative Example 1, where the engine mounts are located behind engines. In FIG. 6, the Y axis represents the vibration level (dB) and the X axis represents the rotational speed (rpm) of the engine. In FIG. 6, the solid line graph a shows results of measurements taken, using the exhaust pipe structure 10 of the present embodiment and the broken line graph b shows results of measurements taken using the exhaust pipe structure 20 of Comparative Example 1. As shown in FIG. 6, the exhaust pipe structure 10 of the present embodiment is reduced more greatly in the vibration level of the up-down vibration of the engine mount than is the exhaust pipe structure 20 of Comparative Example 1. Note that FIG. 6 also shows vibration levels of left-right vibration and front-rear vibration of the engine mount for the purpose of reference, where the vibration levels are measured on the exhaust pipe structure 10 of the present embodiment. In FIG. 6, the dotted line graph c shows measurement results of the vibration level of the left-right vibration and the chain line graph d shows measurement results of the vibration level of the front-rear vibration. As shown in FIG. 6, with the exhaust pipe structure 10 of the present embodiment, on the engine mount, the vibration level of the left-right vibration and the vibration level of the front-rear vibration are lower than the, vibration level of the up-down vibration.

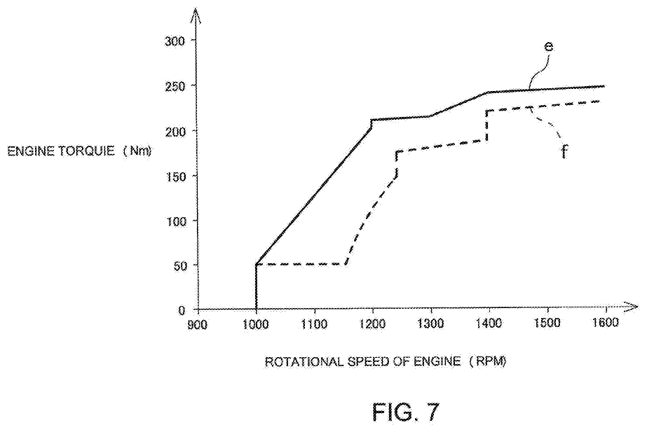

In this way, since the exhaust pipe structure 10 of the present embodiment can more greatly reduce the exhaust pipe-induced vibration of the enginemount and muffled sound inside the vehicle under conditions in which the engine and transmission are coupled than can the exhaust pipe structure 20 of Comparative Example 1, a range in which the engine and transmission can be used in a fully coupled state can be increased. FIG. 7 is a diagram comparing ranges in which an engine and a transmission can be used in a fully coupled state between the exhaust pipe structure 10 of the present embodiment and the exhaust pipe structure 20 of Comparative Example 1. In FIG. 7, the Y axis represents engine torque (Nm) and the X axis represents the rotational speed (rpm) of the engine. In FIG. 7, solid line e indicates the range in which the engine and transmission can be used in a fully coupled state when connected with the exhaust pipe structure 10 of the present embodiment and broken line f indicates the range in which the engine and transmission can be used in a fully coupled state when connected with the exhaust pipe structure 20 of Comparative Example 1. As shown it FIG. 7, the range indicated by solid line e; i.e., the range in which the engine and transmission can be used in a fully coupled state when connected with the exhaust pipe structure 10 of the present embodiment is wider than the range indicated by broken line f; i.e., the range in which the engine and transmission can be used in a fully coupled state when connected with the exhaust pipe structure 20 of Comparative Example 1.

In this way, since the exhaust pipe structure 10 of the present embodiment has a wider range in which the engine and transmission can be used in a fully coupled state than does the exhaust pipe structure 20 of Comparative Example 1, vehicle fuel efficiency and drivability performance can be improved. Also, since the exhaust pipe structure 10 of the present embodiment eliminates the need for the dynamic damper 56 installed in the exhaust pipe structure 20 of Comparative Example 1 to reduce vibration, the present embodiment allows weight reduction by reducing weight co corresponding to the weight of the dynamic damper 56.

The exhaust pipe structure according to the present disclosure is not limited to the form described above, and may be implemented in various forms without departing from the scope of the present disclosure. For example, the intermediate exhaust pipe 4 and rear exhaust pipe 5 may be supported on the vehicle body at positions different from the present embodiment.

1. An exhaust pipe structure connected to a V engine placed transversely in front part of a vehicle, the exhaust pipe structure comprising:
a front bank exhaust pipe connected to an exhaust manifold on a front bank of the V engine;
a rear bank exhaust pipe adapted to connect an exhaust manifold on a rear bank of the V engine to the front bank exhaust pipe;
an intermediate exhaust pipe connected to a downstream side of the front bank exhaust pipe, with a catalytic device being attached to the intermediate exhaust pipe; and
a rear exhaust pipe connected to a downstream side of the intermediate exhaust pipe, with a muffler being attached to the rear exhaust pipe;
wherein the front bank exhaust pipe and the intermediate exhaust pipe are connected with each other via a ball joint,
the intermediate exhaust pipe and the rear exhaust pipe are connected with each other via a hail joint, and
a flexible pipe, elastically deformable, is attached to the front bank exhaust pipe on a side upstream of a branched section between the front bank exhaust pipe and the rear bank exhaust pipe.

2. The exhaust pipe structure according to claim 1, wherein the flexible pipe is placed under an oil pan of the V engine.
